(19) United States
(12) Patent Application Publication
(10) Pub. No.: US 2002/0006242 A1
(43) Pub. Date: Jan. 17, 2002

(54) Synchronizer ring

(76) Inventors: Christof Eberspacher, Esslingen (DE); Martin Gausmann, Muggensturm (DE); Stefan Grau, Dautphetal-Wolfgruben (DE); Tilman Haug, Weissenhorn (DE); Patrick Izquierdo, Ulm (DE); Hansjorg Zeller, Wolfschlungen (DE); Jorg Zurn, Stuttgart (DE); Wolfgang Reichle, Lenningen (DE); Reinhard Rosert, Dresden (DE)

Correspondence Address: EVENSON, McKEOWN, EDWARDS & LENAHAN, P.L.L.C., 1200 G Street, N.W., Suite 700, Washington, DC, 20005, US

(21) Appl. No.: 09/824,570

(22) Filed: Apr. 3, 2001

(30) Foreign Application Priority Data
Apr. 6, 2000 (DE) 100 17 285.7

(51) Int. Cl. B32B 15/16; B05D 1/02; B05D 3/00; B05D 1/08; B05D 3/12

(52) U.S. Cl. 384/912; 428/553; 428/564; 384/913; 428/937; 427/421; 427/446; 427/299; 427/355

(57) ABSTRACT

The present invention relates to a synchronizer ring having an annular body which has a sliding region, the sliding region being provided with a wear-resistant tribological coating. According to the invention, it is provided for the tribological coating to be a thermally sprayed coating which contains a maximum of approximately 40% by weight of solid lubricant.

This application claims the priority of German application 100 17 285.7, filed Apr. 6, 2000, the disclosure of which is expressly incorporated by reference herein.

### BACKGROUND OF THE INVENTION

The present invention relates to a synchronizer ring, having a ring body which has a sliding region, the sliding region being provided with a wear-resistant tribological coating.

Synchronizer rings of the generic type are known, for example, from German publication DE 42 40 157 A1, U.S. Pat. No. 5,337,872, European publication EP 0 070 952 A1, and U.S. Pat. No. 4,995,924.

The known synchronizer rings have tribological coatings made from wear-resistant material. These may, for example, be copper alloys, molybdenum coatings and the like. Brass and molybdenum coatings are generally applied to the sliding region of the synchronizer ring by thermal spraying. In the prior art, copper alloys, preferably with tin or zinc, are applied in the form of stray sintering foils, i.e. as a frictional foil. The frictional foil is attached to a plate, which in turn is attached to the sliding region of the synchronizer ring.

A problem with the molybdenum or brass coatings is that these are coatings which offer little comfort, so that the transmissions are difficult to shift. Moreover, the trend in transmission development is towards pneumatically/electronically controlled transmissions, in which, in particular in the case of commercial vehicles, considerable differences in speed between the sliding sleeve and the synchronizer ring may occur. However, as a result the performance limit of the known molybdenum coatings is reached and the sliding sleeve becomes worn very rapidly. Furthermore, these coatings also have a toxic action and are hazardous for this reason. The stray sintering foils made from porous copper alloys, by contrast, do offer sufficient comfort when shifting gears, but become worn relatively quickly. The separate bonding to the sliding region of the synchronizer ring represents an additional problem.

### SUMMARY OF THE INVENTION

Therefore, it is an object of the present invention to provide a synchronizer ring of the abovementioned type which is simultaneously resistant to wear and provides comfort and can be applied to the sliding region in the most simple manner possible.

The solution is to have the tribological coating be a thermally sprayed coating which contains a maximum of about 40% by weight of solid lubricants. Therefore, according to the invention it is provided for the coating to contain a wear-resistant solid lubricant, such as in particular titanium dioxide (TiO₂), calcium fluoride (CaF₂), hexagonal boron nitride (h-BN), graphite, lead (Pb) and/or MoS₂. Thermal spraying in turn allows a porous microstructure of the coating to be produced, by setting suitable spraying parameters. In this way, it is possible to form oil displacement channels, which lead to improved wetting by the film of lubricant, without machining. A result is a particularly advantageous comfort provided by the synchronizer ring according to the invention.

According to the invention, the production process is distinguished by the fact that a spraying compound which in total contains at most about 40% by weight in particular of one or more of the solid lubricants mentioned as being preferred is used. The coating can be applied directly to the sliding region, so that good bonding of the coating to the synchronizer ring is ensured. Further machining is not required.

Advantageous refinements will emerge from the subclaims. The solid lubricant preferably has a particle size of up to approximately 180 μm, preferably between 50 μm and 180 μm. A preferred embodiment of the coating provides for it to contain tin and/or zinc and/or silicon and/or nickel and/or manganese and/or copper and/or aluminium and/or one or more of their oxides and/or one or more of their carbides and/or one or more of their nitrides and/or carbon. The coating may have a porosity of up to 30%.

Accordingly, when applying the coating it is preferable to use a spraying compound which contains tin and/or zinc and/or silicon and/or nickel and/or manganese and/or copper and/or aluminium and/or one or more of their oxides and/or one or more of their carbides and/or one or more of their nitrides and/or carbon.

In a particularly preferred embodiment, the coating is applied using a wire arc spraying process, in which case the spraying compound used is preferably a filled wire.

The filled wire preferably has a filling which contains titanium dioxide (TiO₂), calcium fluoride (CaF₂), hexagonal boron nitride (h-BN), graphite, lead (Pb) and/or molybdenum sulphide (MoS₂).

In particular, the filling of the wire may additionally contain tin and/or zinc and/or silicon and/or nickel and/or manganese and/or copper and/or aluminium and/or one or more of their oxides and/or one or more of their carbides and/or one or more of their nitrides and/or carbon.

As a result of the use of a filled wire of this type, a coating produced therefrom has a solid lubricant fraction of at most approximately 40% by weight. The covering of the filled wire preferably consists of copper and/or tin and/or zinc and/or aluminum.

A further preferred embodiment provides for a combination of a filled wire and a solid wire, preferably made from a copper/aluminium alloy, to be used. As an alternative to a wire arc spraying process, it is also possible to use other thermal spraying processes, for example plasma spraying or a flame spraying process, in particular high-speed and/or wire flame spraying.

Remachining of the coating is possible but not absolutely necessary. For example, it is possible to provide the coating with a stamping, for example by means of a ram.

In a further expedient configuration, the filled wire comprises a copper shell and a filling of tin, zinc and titanium dioxide.

The quantities of the individual constituents of a filled wire according to the invention are adapted to one another in such a way that the coating which results through a wire arc spraying process or flame spraying process, in particular a high-speed and/or wire flame spraying process, has the composition Cu/5Sn8Zn1Mn2Ni1Si40X, where X represents one or more of in particular the abovementioned solid lubricants and particularly preferably represents TiO₂.

A further variant consists in using a combination of a filled wire and a solid wire in the wire arc spraying process, the filled wire having the composition which has just been described and the solid wire consisting of CuAl8. The porous microstructure results from suitable spraying parameters being set.

### BRIEF DESCRIPTION OF THE DRAWINGS

An exemplary embodiment of the present invention is explained below with reference to the appended figures, in which:

FIG. 1 shows a diagrammatic illustration of an embodiment of a synchronizer ring according to the invention;

FIG. 2 shows a section on line II-II in FIG. 1;

FIG. 3 shows a diagrammatic illustration of a filled wire.

### DESCRIPTION OF THE PREFERRED EMBODIMENTS

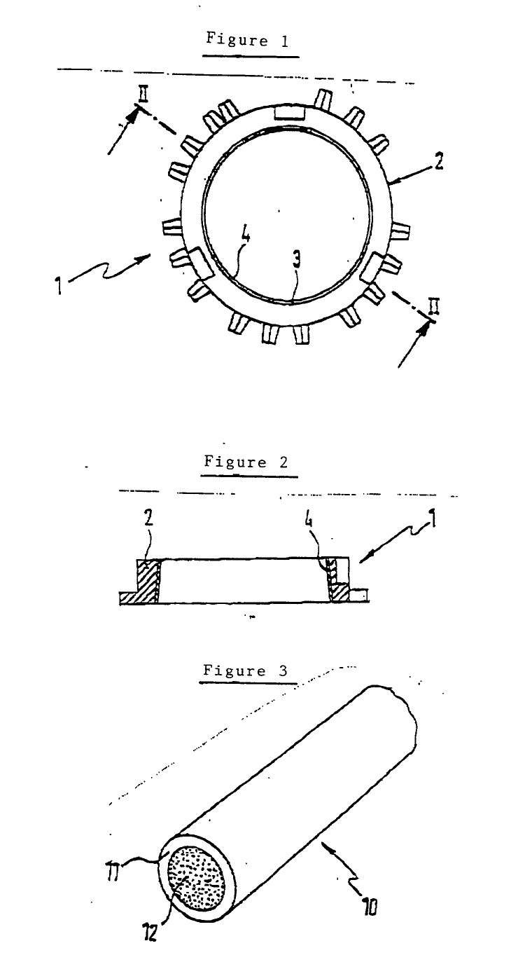

The embodiment of a synchronizer ring 1 according to the invention which is diagrammatically depicted in FIG. 1 has an internal sliding face. The synchronizer ring therefore slides on a transmission cone along its inner circumference. The synchronizer ring 1 has a ring body 2 and a wear-resistant tribological layer 4 on the surface of the inner circumference 3 of the ring body 2. The ring body 2 is made from metal or metal alloy, for example iron, copper or aluminium or their alloys.

According to the invention, the wear-resistant tribological layer 4 contains less than 40% by weight titanium dioxide. The particle size of the TiO₂ is at most approximately 180 μm. The layer 4 also contains tin, zinc, silicon, manganese, nickel, copper and/or aluminium in variable proportions. As well as being in elemental form, these materials may also be present in the form of carbides and/or in the form of oxides and/or in the form of nitrides. In addition, the layer 4 may also contain carbon. The coating has a porosity of up to approximately 30%, preferably approximately 20%.

To produce the layer 4, the surface of the inner circumference 3 of the ring body 2 was initially roughened, for example sand-blasted and degreased. Then, the layer 4 was applied by the wire arc spraying process, which is known per se, using one or two filled wires. If only one filled wire is used, the second wire consisted of CuAl8. After it had been applied, the layer 4 was stamped with the aid of a ram (not shown).

A filled wire 10 is diagrammatically depicted in FIG. 3. It has a covering 11 of aluminium or CuAl8 and a filling 12 which contains less than 40% by weight titanium dioxide with a particle size of up to approximately 200 μm, preferably up to 180 μm and particularly preferably up to approximately 150 μm.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. Synchronizer ring, having a ring body (2) which has a sliding region, the sliding region being provided with a wear-resistant tribological coating, characterized in that the tribological coating (4) is a thermally sprayed coating which contains a maximum of approximately 40% by weight of a solid lubricant.

2. Synchronizer ring according to claim 1, characterized in that the solid lubricant is titanium dioxide (TiO₂), calcium fluoride (CaF₂), hexagonal boron nitride (h-BN), graphite, lead (Pb) or molybdenum sulphide (MoS₂) or any desired mixture of these substances.

3. Synchronizer ring according to claim 1, characterized in that the solid lubricant has a particle size of up to approximately 200 μm and preferably of between 50 μm and 180 μm.

4. Synchronizer ring according to one of the preceding claims, characterized in that the thermally sprayed coating (4) furthermore contains tin and/or zinc and/or silicon and/or nickel and/or manganese and/or copper and/or aluminium and/or one or more of their oxides and/or one or more of their carbides and/or one or more of their nitrides and/or carbon.

5. Synchronizer ring according to one of the preceding claims, characterized in that the thermally sprayed coating has a porosity of up to approximately 30%.

6. Process for applying a wear-resistant tribological coating to the sliding region of a synchronizer ring, characterized in that the coating (4) is thermally sprayed, a spraying compound which contains at most approximately 40% by weight of a solid lubricant being used.

7. Process according to claim 6, characterized in that the solid lubricant used is titanium dioxide (TiO₂), calcium fluoride (CaF₂), hexagonal boron nitride (h-BN), graphite, lead (Pb) or molybdenum sulphide (MoS₂) or any desired mixture of these solid lubricants.

8. Process according to claim 6, characterized in that a spraying compound is used which furthermore contains tin and/or zinc and/or silicon and/or nickel and/or manganese and/or copper and/or aluminium and/or one or more of their oxides and/or one or more of their carbides and/or one or more of their nitrides and/or carbon.

9. Process according to claim 6, characterized in that the coating is applied in a wire arc spraying process and/or a flame spraying process.

10. Process according to claim 9, characterized in that the spraying compound used is a filled wire which has a filling which contains a solid lubricant and, if appropriate, tin and/or zinc and/or silicon and/or nickel and/or manganese and/or copper and/or aluminium and/or one or more of their oxides and/or one or more of their carbides and/or one or more of their nitrides and/or carbon.

11. Process according to claim 10, characterized in that a filled wire with a covering of copper and/or tin and/or zinc and/or aluminium and/or their alloys is used.

12. Process according to one of the preceding claims, characterized in that, in addition to a filled wire, a solid wire, preferably made from CuAl8, is used as the spraying compound.

13. Process according to one of claims 6 to 12, characterized in that the sliding region (3), prior to the application of the coating (4), is roughened, preferably sand-blasted and degreased.

14. Process according to one of claims 6 to 13, characterized in that the coating (4) is stamped after it has been applied.
